(19) United States
(12) Patent Application Publication
(10) Pub. No.: US 2026/0133559 A1
(43) Pub. Date: May 14, 2026

(54) SYSTEMS AND METHODS FOR PREDICTING WEAR CONDITION OF A GROUND ENGAGING TOOL OF A MACHINE

(71) Applicant: Caterpillar Inc., Peoria, IL (US)

(72) Inventors: Grant KOCHER, Mount Zion, IL (US); Wenming ZHAO, Dunlap, IL (US); Cheng YU, Edwards, IL (US); Daojie ZHANG, Northbrook, IL (US); David B. PARZYNSKI, Peoria, IL (US); Thomas CONGDON, Dunlap, IL (US); Rammagy YOEU, Dunlap, IL (US); Pasita PIBULCHINDA, Peoria, IL (US)

(73) Assignee: Caterpillar Inc., Peoria, IL (US)

(21) Appl. No.: 18/944,493

(22) Filed: Nov. 12, 2024

(51) Int. Cl. G05B 19/4065

(52) U.S. Cl. CPC G05B 19/4065

(57) ABSTRACT

Systems and methods for determining the wear of one or more components of a machine is disclosed. The method includes receiving sensor data from the sensor(s) associated with the machine. The sensor data is processed by a wear model for determining a change in performance and/or wear rate of the component(s). The estimated wear of the component(s) is generated with the wear model and based on the change in performance and/or the wear rate. Displaying an indication representing the estimated wear of the component(s) on a user interface.

### TECHNICAL FIELD

The present disclosure relates generally to the field of monitoring and diagnosis, and more particularly, to a monitoring system that combines a plurality of sensors and algorithm modalities for monitoring the structural wear of one or more components (e.g., ground engaging tools (GETs)) of an industrial machine.

### BACKGROUND

Machines equipped with work tools, such as cutting edges for blades, shank tips for rippers and scarifiers, and teeth for buckets, are subject to significant wear due to continuous material handling. Traditionally, wear monitoring has been conducted through physical inspection of the worn parts, which presents several challenges. This method is labor-intensive, time-consuming, and prone to human error, leading to incorrect assessment of wear severity. For example, manual inspections often rely on visual analysis or camera images, which can be inaccurate due to environmental factors such as dirt, debris, or mud obscuring the components. These obstructions can lead to incorrect analysis of the actual wear. As machines evolve towards remote control and autonomous operation, the need for an advanced, remote wear monitoring is increasingly important. Current manual methods are inadequate for real-time, continuous monitoring, and do not provide precise data to predict wear patterns or maintenance schedules. Additionally, without real-time data, unexpected failure can occur, resulting in costly machine downtime, reduced efficiency, and potential safety hazards.

U.S. Patent Application Publication No. 2023/0053154 A1, published on Feb. 16, 2023 (“the '154 publication”), describes a method for determining the wear level of a GET by analyzing images from various sensors and calculating geometric parameters and image points to assess wear. The '154 publication relies on image-based analysis to determine wear, which is susceptible to inaccuracies due to environmental factors like dirt obscuring the tools. The '154 publication does not disclose a method for utilizing modeling techniques for wear prediction.

The system of the present disclosure may solve one or more of the problems set forth above and/or other problems in the art. The scope of the current disclosure, however, is defined by the attached claims, and not by the ability to solve any specific problem.

### SUMMARY

In one aspect, a computer-implemented method for determining wear of one or more components of a machine is disclosed. The computer-implemented method includes: receiving sensor data from one or more sensors associated with the machine; processing the sensor data by a wear model for determining a change in performance and/or a wear rate of the one or more components; generating an estimated wear of the one or more components with the wear model and based on the change in performance and/or the wear rate; and displaying an indication representing the estimated wear of the one or more components on a user interface.

In another aspect, a system for determining wear of one or more components of a machine is disclosed. The system includes: one or more processors, and at least one non-transitory computer readable medium storing instructions which, when executed by the one or more processors, cause the one or more processors to perform operations including: receiving sensor data from one or more sensors associated with the machine, wherein the sensor data includes one or more of: blade position data, load severity data, or soil condition data; inputting the sensor data into a wear model for calculating wear rate and simulating a predicted wear of the one or more components; and generating a three-dimensional model of the predicted wear, wherein the three-dimensional model indicates one or more of: worn geometry, worn volume, or wear rate of the one or more components.

In yet another aspect, a non-transitory computer readable medium for determining wear of one or more components of a machine is disclosed. The non-transitory computer readable medium storing instructions which, when executed by one or more processors of a computing system, cause the one or more processors to perform operations including: receiving sensor data from one or more sensors associated with the machine; processing the sensor data by a wear model for determining a wear volume rate of the one or more components; and generating an estimated wear of the one or more components based on the wear volume rate.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a diagram of an exemplary machine, according to aspects of the disclosure.

FIG. 2 is a schematic illustration of a system for determining a condition of one or more components of the machine of FIG. 1.

FIGS. 3A-3C are exemplary outputs of the system of FIG. 2.

FIG. 4 is a diagram that illustrates a graph for determining a condition of one or more components of the machine of FIG. 1.

FIG. 5 is a flowchart of a process implemented by the system of FIG. 2.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

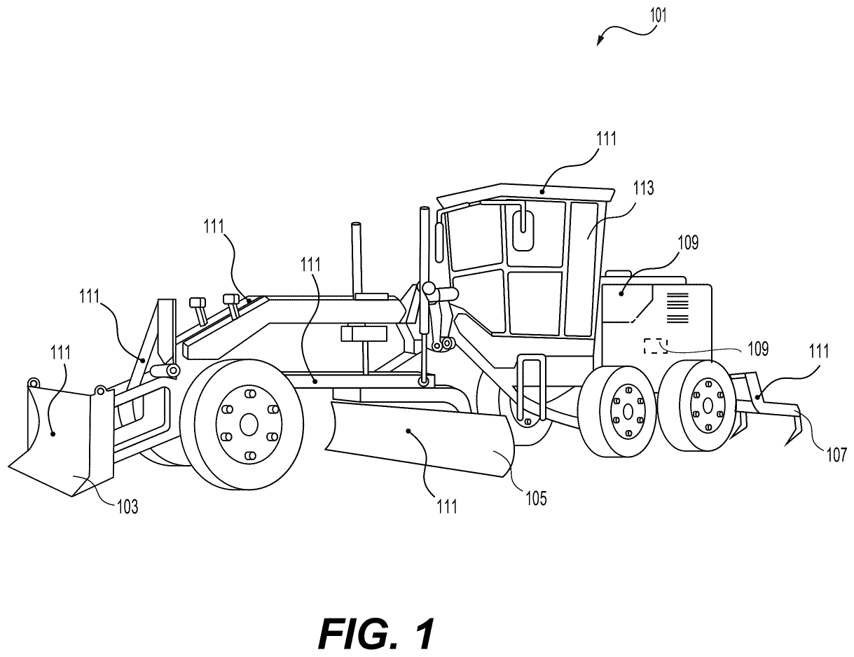

FIG. 1 is a schematic diagram of an exemplary machine 101. Although FIG. 1 illustrates machine 101 as being a motor grader, machine 101 may include any type of industrial machine. For example, machine 101 may be a digging machine (e.g., a backhoe, dozer, trencher, dragline, or any other similar machine) or a loading machine (e.g., wheeled or tracked loader, an excavator, a rope shovel, a stacker reclaimer, or any other similar machine). In one example, machine 101 may be actively engaged in various tasks using its components, each of which may experience wear during operation. Machine 101 may be equipped with a front blade 103 for moving loose materials such as soil, gravel, or sand, allowing for efficient clearing and material transport. Machine 101 may be equipped with an adjustable moldboard blade 105 for levelling material, creating a smooth and even work area for construction or various maintenance tasks. Machine 101 may also be equipped with a ripper assembly 107 for breaking hard-packed soil or rocks for easier grading and material handling. In addition to the front blade 103, adjustable moldboard blade 105, and ripper assembly 107, machine 101 may also include various components, such as (i) mid-mount scarifier teeth to loosen hard materials (e.g., breakup compacted soil, gravel, or asphalt surfaces), (ii) front scarifier teeth for grading and levelling, (iii) front blade cutting edges for pushing materials like dirt, snow, or gravel, and (iv) front snow plows (V-plow) for moving materials and snow removals. Given the intense force exerted on these components during operation, wear may be monitored.

Monitoring the wear of components of machine 101, such as the front blade 103, moldboard blade 105, and ripper assembly 107 may be essential for maintaining the operational efficiency of the equipment. FIG. 1 shows sensors 111 positioned at specific locations of machine 101, however, it should be understood that sensors 111 may be positioned anywhere on machine 101 to enable comprehensive data collection and real-time monitoring of various operational and conditional parameters. The sensors 111 may include linear displacement sensors, rotary encoders, accelerometers, global positioning system (GPS) sensors, inertial measurement units (IMUs), strain gauges, load cells, load sensing cylinders, force transducers, ground-penetrating sensors, pressure sensors, temperature sensors, or vibration sensors.

In one example, linear displacement sensors may be mounted near the moldboard blade 105 to track its movement and positioning during operation, allowing for early detection of misalignment or excessive wear. In one example, pressure sensors may be installed on the hydraulic system of the front blade 103 to monitor the weight and force applied to the front blade 103 when moving material, helping identify stress on the blade and the attachment points for front blade 103. In another example, load sensors may be positioned on the ripper assembly 107 to measure forces exerted during penetration, ensuring wear on the ripper teeth and shank is tracked. The vibration sensors may be placed on or near the machine's frame to detect vibrations that may signal wear and wear-induced imbalances, while strain gauges on load-bearing areas, such as the blade and ripper arms, may facilitate force and structural fatigue tracking.

Machine 101 may be autonomous, semi-autonomous, manually-operated, or controlled remotely, allowing for optimized performance in diverse work environments. The cabin 113 of machine 101 is configured to enclose an operator therein, and may include a user interface that may provide a display of the wear status of one or multiple components of machine 101 (e.g., front blade 103, moldboard blade 105, ripper assembly 107) by showing wear rates, worn volume, and/or remaining operational lifespan. For example, plowing materials (e.g., soil, snow, debris) expose front blade 103 to constant friction, impact, and abrasive forces as they engage with various materials like soil, rock, and debris. Through visual indicators like color-coded alerts or graphs, the user interface may highlight wear points, allowing the operator to take preventive measures. The interface may also display diagnostic data from the sensors 111, offering a clear and actionable view of machine health and component wear trends.

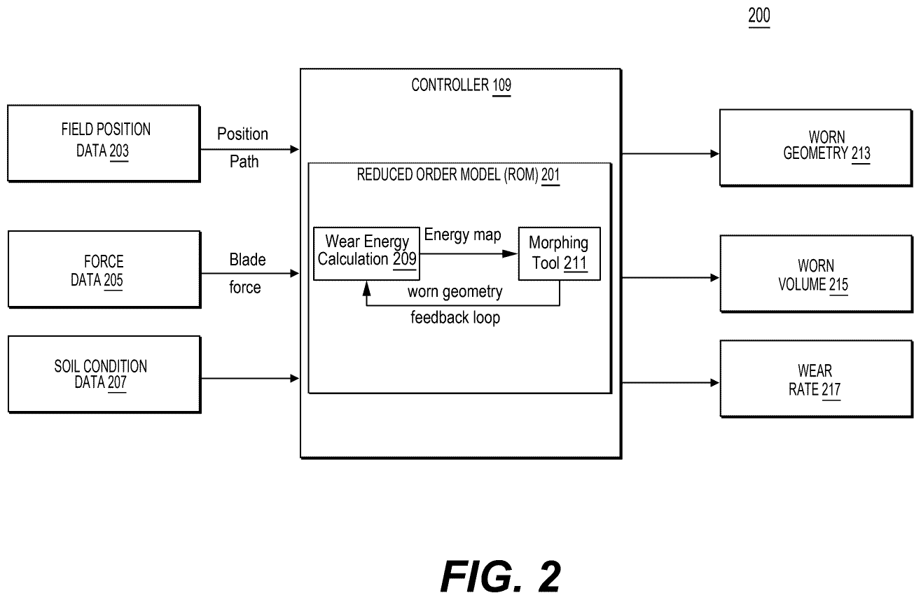

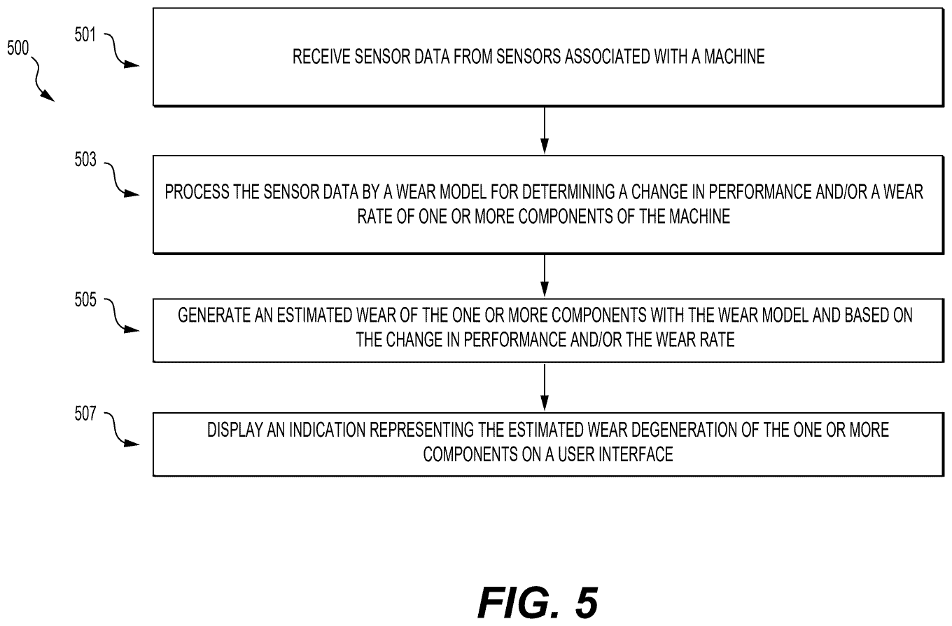

FIG. 2 illustrates system 200 for determining, in real-time, near real-time, or periodically, the condition of one or more components of machine 101. The system 200 includes a controller 109 for monitoring or managing wear of the machine 101. In one instance, controller 109 may be communicably coupled to the sensors 111. The controller 109 may include any appropriate hardware, software, firmware, etc. to carry out the methods described in this disclosure, including the method of FIG. 5. The controller 109 may include one or more processors, memory, a secondary storage device, communication systems, and/or other appropriate hardware. The processors may be, for example, a single or multi-core processor, a digital signal processor, a microcontroller, a general purpose central processing unit (CPU), a field programmable gate array (FPGA), a graphics processing unit (GPU), and/or other conventional processor or processing/controlling circuit or controller. The processors may embody microprocessors, for example, a single microprocessor or multiple microprocessors.

The memory or secondary storage device associated with controller 109 may be non-transitory computer-readable media that store data and/or software routines that may assist controller 109 in performing its functions. In these aspects, the memory or secondary storage device may include, for example, read-only memory, random access memory, flash or other removable memory, or any other appropriate and conventional memory. Further, the memory or secondary storage device associated with controller 109 may also store data received from the various sensors 111.

In one instance, controller 109 may rely on input from various sensors (e.g., sensors 111) placed throughout machine 101. Controller 109 may be programmed with a reduced-order model (ROM) 201 to optimize maintenance strategies. ROM 201 may receive field position data 203, force data 205, and soil condition data 207 from sensors 111. In one example, ROM 201 may receive field position data 203 from global positioning system (GPS) sensors or inertial measurement units (IMUs). The field position data 203 may include real-time information on the location and orientation of a machine's components, such as the blade, boom, or bucket, during operation. Captured by the sensors, this data may provide insight into how the machine interacts with its environment, tracking angles, depths, and tilts during tasks like digging or material handling. In one example, ROM 201 may receive force data 205 from load cells, load sensing cylinders, or force transducers. The force data 205 may include real-time measurements of the forces exerted on various components of machine 101. These forces may include the pressure or load experienced by the components as they interact with the ground or move materials. In one example, ROM 201 may receive soil condition data 207 from ground-penetrating sensors, pressure sensors, or vibration sensors. The soil condition data 207 may indicate characteristics of the terrain in which machine 101 is operating, for example, soil composition, moisture content, or hardness. Soil conditions may significantly affect the wear and performance of GETs as harder or more abrasive soils can lead to faster wear, while softer soils may cause less stress on the components.

In one instance, ROM 201 may be a computation framework designed to simplify complex systems by reducing the number of variables or equations needed to accurately represent the system's behavior. ROM 201 may take input from various sensors that monitor the operational parameters such as force, position, load severity, and soil conditions. These inputs may be processed using pre-defined physics-based equations, like those representing wear volume rate to predict the wear of components.

In another instance, ROM 201 may integrate machine-learning techniques to enhance its ability to predict component wear. By utilizing machine-learning algorithms, the ROM 201 may analyze vast amounts of real-time sensor data to identify patterns and correlations. The machine-learning algorithms may be trained on historical performance data, learning to recognize how variations in operating conditions influence wear rates. By continuously learning from both historical and real-time data, the ROM 201 with machine-learning algorithms can make precise predictions.

In one instance, ROM 201 may compare real-time sensor data (e.g., field position data 203, force data 205, and soil condition data 207) with historical performance data to identify deviations that indicate changes in performance and predict wear rates. In one example, ROM 201 may analyze field position data 203 to assess performance, detect mechanical strain, and predict wear rates by understanding the spatial positioning of components over time, leading to improved maintenance and operational efficiency. In one example, ROM 201 may analyze the force data 205 to assess the stress levels and mechanical strain on the components, which are indicators of performance degradation or wear. In one example, ROM 201 may leverage soil condition data 207 by incorporating it into predictive algorithms, allowing for a more accurate estimation of the wear of machine components. For example, machine-learning models within the ROM 201 may analyze historical data to determine how different soil types impact wear rates, adjusting predictions based on the specific conditions encountered. By processing these data, ROM 201 may estimate wear volume rates, and predict the remaining useful life of the components. This enables the system to generate more accurate predictions of wear and may facilitate timely maintenance.

In one instance, ROM 201 may operate in a continuous feedback loop to accurately predict wear on components through a sequence of interconnected processes. The loop may begin with a wear energy calculation 209 receiving sensor data. In one example, the sensor data may include: (i) force data indicating normal force applied to the components, (ii) speed data indicating the speed at which the GETs slide over the ground surface, (iii) material property data of the GETs, and/or (iv) soil condition data including soil type, density, or moisture content. The wear energy calculation may estimate the energy exerted in the component during an operation based on sensor data. This energy calculation may be fed into a morphing tool 211, which simulates how the component's geometry changes due to wear over time. The morphing tool 211 dynamically adjusts the geometry of the components to reflect wear progression. This worn geometry is then fed back into the wear energy calculation, updating the model with the new physical shape of the component. This continuous loop may allow ROM 201 to refine its predictions, accounting for the evolving state of the component.

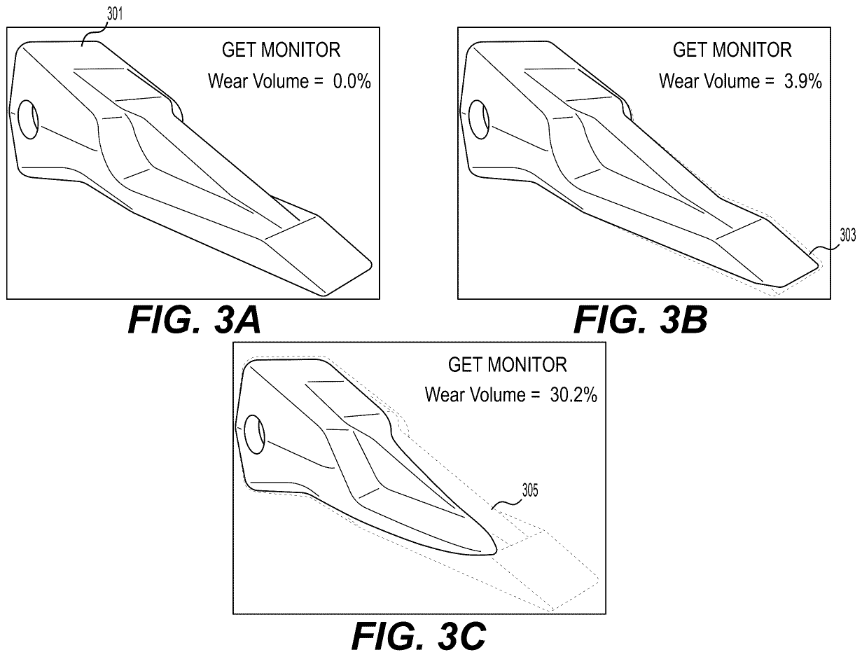

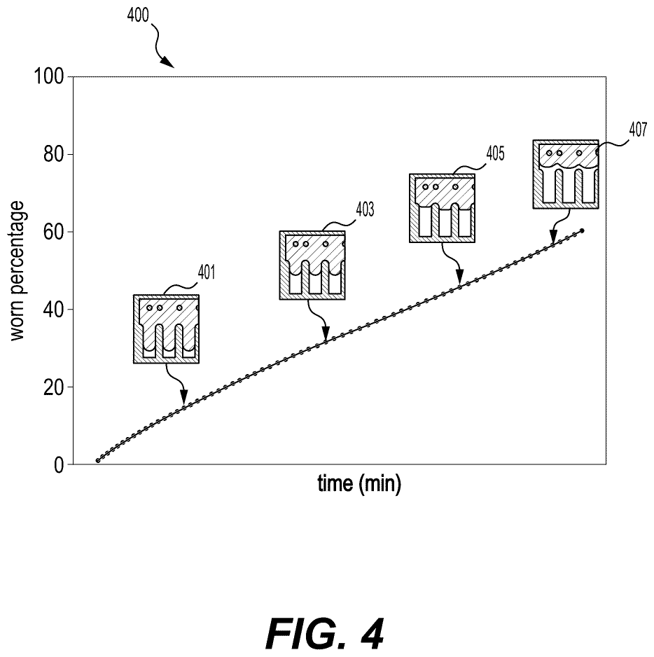

In one instance, ROM 201 may output worn geometry 213, worn volume 215, and wear rate 217 (as illustrated in FIGS. 3A-3C and 4). The worn geometry 213 may visually represent the component's current physical state after wear. The worn volume 215 may quantify the total material lost due to wear. The wear rate 217 may provide an estimate of how quickly the component is deteriorating under current operating conditions, assist in predicting potential failures, inform design improvement by highlighting areas of excessive wear, and/or facilitate performing benchmarking against similar components. These outputs give a comprehensive view of the component's wear.

FIGS. 3A-3C illustrates three-dimensional simulations of a ripper shank tip of machine 101 at different stages of wear. In one instance, the ROM 201 may generate three-dimensional simulations of component wear on user interfaces of devices associated with the users (e.g., worn geometry 213). The three-dimensional simulations may represent a progression of wear in a visual model, the illustrating example representing the condition of a ripper shank tip (e.g., of ripper assembly 107) over time as the tip interacts with materials during operation.

FIG. 3A displays the ripper shank tip with a wear volume of 0%, indicating the tip is in good condition with no wear. The three-dimensional model 301 shows the sharp edges and full structural integrity of the component as it would appear when new. FIG. 3B displays the ripper shank tip with a wear volume of 3.9%. FIG. 3B represents wear that is relatively minimal with three-dimensional model 303 showing slight erosion or rounding of the tip edges. This stage signifies early wear and degradation of the tipper shank tip. FIG. 3C displays the ripper shank tip with a wear volume of 30.2%. The three-dimensional model 305 shows significant wear, with a noticeable reduction in the material at the end of the shank tip. The three-dimensional model 305 shows clear signs of material degradation, where a substantial portion of the tip has been worn down. At this stage replacement or maintenance may be beneficial. These three-dimensional simulations provide visual representation of the wear process, which may be used to predict future wear rates and guide maintenance decisions.

An alternative approach may be employed where the system may utilize methods other than three-dimensional simulations, or in addition to three-dimensional simulations, to monitor and assess component wear. In one instance, ROM 201 may compute and display the wear percentage of the components of machine 101 based on sensor data. The ROM 201 may analyze the operational parameters, such as force, speed, and soil condition, and directly calculate the wear percentage using pre-defined algorithms described herein. This wear percentage may be updated in real-time as new sensor data is received, facilitating an increasingly computationally-efficient method of monitoring wear. Additionally, various other methods, such as numerical analysis, predictive algorithms, or statistical models, may be used to assess component degradation.

FIG. 4 illustrates graph 400 for determining the condition of the component (e.g., a tooth or a blade) of machine 101. The ROM 201 may process data from sensors 111 that monitors various parameters of the GETs, such as the blade and tooth configuration, to track wear progression. In this example, the blade may be positioned at a horizontal angle with a tilt of a certain degree relative to the ground, while the tooth has a specific height and a set cutting depth. The ROM 201 may monitor the wear volume, which has already reached a substantial portion of the tooth's total volume, indicating significant wear progression. Based on operational data, the estimated time for significant wear for the tooth may be determined.

In one instance, ROM may be configured to perform calculations triggered by specific events that contribute to wear (e.g., sudden increase in load severity, changes in blade position, variation in soil condition, or other operational conditions known to accelerate wear), operational thresholds (e.g., exceeding pre-defined limits of force), per schedule, or environmental condition change. In this example, the ROM 201 may perform calculations every minute amounting to, for example, greater than approximately 5, 000 iterations over an operational period. During each iteration, the ROM 201 may process sensor inputs, calculate wear rates, and update wear predictions. Morphing, an advanced recalculation process that adjusts the three-dimensional model of the component(s) to reflect wear may occur for some, or all, of these iterations. In one example, morphing is performed once for every 30 iterations, 50, iterations, 70 iterations, 100 iterations, etc., to reduce computational load. This continuous monitoring and recalibration allow the system to maintain an accurate representation of the component's wear status and provide timely insights for maintenance or replacement.

The graph 400 visually represents the wear progression of the tooth over time, with the y-axis showing the percentage of wear (ranging from 0% to 100%) and the x-axis indicating time. The example data points in graph 400 illustrate the tooth's wear progression, for example:
At point 401: The tooth experiences a relatively minor wear;
At point 403: The tooth experiences increased wear;
At point 405: The tooth experiences moderate wear;
At point 407: The tooth experiences extensive wear;

These intersection points (401, 403, 405, and 407) may provide a clear, quantitative view of how the wear increases over time. The steady rise in wear percentage indicates that the ROM 201 is tracking the degradation of the component in real-time or at a series of intervals.

This data may allow operators to identify the current level of wear, predict future wear, and plan timely maintenance, for example, based on when wear thresholds (e.g., 60%, 80%, 90%, 100%) are reached or expected to be reached. Additionally, graph 400, calculated wear values or other data associated with graph 400, and/or images generated for display may assist in visualizing wear trends, giving users a better understanding of component life cycles and how different operating conditions impact wear rates.

### INDUSTRIAL APPLICABILITY

The disclosed methods and systems for predicting conditions of various components of a machine may be used in any type of machine associated with an industry such as construction, mining, farming, transportation, or any other industry known in the art. By leveraging sensor data and a reduced-order model (ROM), the method may provide the ability to accurately predict wear and tear on components without relying solely on visual inspections, which can be hindered by environmental factors like dirt or debris. The method may facilitate proactive maintenance by providing precise estimates of wear rates, thereby preventing unplanned breakdowns and reducing the likelihood of costly repairs. The method may generate predictions to address potential issues before they escalate, such a preventive approach ensures that the equipment continues to perform effectively for a longer period and extends the overall lifespan of the machines.

FIG. 5 is a flowchart of a process for predicting conditions (e.g., wear condition) of one or more components of machine 101. In one instance, ROM 201 may perform one or more portions of the process 500 and are implemented using, for instance, a chip set including a processor and a memory of controller 109. The processor is configured to perform such processes by having access to instructions (e.g., software or computer-readable code) stored in the memory that, when executed by one or more processors, cause one or more processors to perform the processes. Although the process 500 is illustrated and described as a sequence of steps, it is contemplated that various embodiments of the process 500 are performed in any order or combination and need not include all of the illustrated steps.

In step 501, the ROM 201 may receive sensor data from sensors 111 associated with machine 101. In one example, the sensors 111 may include linear displacement sensors, rotary encoders, accelerometers, global positioning system (GPS) sensors, inertial measurement units (IMUs), strain gauges, load cells, load sensing cylinders, force transducers, ground-penetrating sensors, pressure sensors, temperature sensors, or vibration sensors. The sensors 111 may be strategically positioned on machine 101 to capture key operational parameters such as total blade position, load severity, hydraulic pressure, or force distribution during the machine's operation. The data collected may include both static and dynamic inputs, such as the machine's movement, environmental conditions, soil conditions, and forces exerted on ground-engaging tools (GET) like the front blade 103 or moldboard blade 105.

In one example, the displacement sensors, rotary encoders, or accelerometers may determine the position of the front blade 103, providing data on the blade's angle and depth during operation, which influences wear patterns. In another example, the pressure sensors may measure the weight of the material being handled by determining the pressure of hydraulic fluid, allowing for insights into the load exerted on the GET and facilitating in identifying stress points that contribute to the wear. In a further example, load cells may quantify the forces acting on various components, enabling the detection of peak loads that may accelerate wear. In another example, temperature sensors may monitor the heat generated during operation, which may indicate excessive friction and potential degradation of materials.

In step 503, the ROM 201 may process the sensor data for determining a change in performance and/or a wear rate (e.g., wear volume rate) of the component(s) of machine 101.

The change in performance may refer to any deviation in the component's operational efficiency, effectiveness, or functionality, often indicated by variations in wear rates, load handling, or response to operational demand. In one instance, the sensor data from sensors 111 may include blade position data, load data (e.g., load severity data), and/or soil condition data. The ROM 201 may monitor, continuously or periodically, the position of the edges (e.g. blades) of the component(s) of machine 101 throughout the operational cycles for detecting deviations, angular positioning, or elevation of the blades relative to the ground surface. For example, ROM 201 may process the blade position data to monitor how the blade's depth, angle, and movement change over time, revealing inefficiencies such as improper alignment or reduced precision, which may indicate wear or mechanical issues. The ROM 201 may monitor, in real-time or near real-time, dynamic load fluctuations and/or peak forces during tool operation for assessing operational stress to the component(s) of machine 101. In one instance, dynamic load fluctuations may indicate variation in load experienced by the components of machine 101 during operation, which may impact their wear rates and performance. In one instance, peak forces may be the maximum load exerted on the components of machine 101 at any given moment, often occurring during critical operational tasks, and may significantly contribute to accelerated wear. For example, ROM 201 may process load severity data to measure the forces exerted on the blade or other GETs, and if machine 101 requires more force to perform the same tasks (e.g., digging or lifting), it may indicate that the components, such as the blade or the hydraulic system are under increased stress leading to wear or damage.

In one instance, the ROM 201 may determine the wear rate of the component(s) of machine 101 based on the hardness of the surface of the component(s). For example, harder materials (e.g., high-grade steel) used in front blade 103 may resist wear more effectively, and the wear rate is lower compared to softer materials. The ROM 201 may utilize such material properties to refine its prediction on how quickly the component may degrade during operation. In one instance, the ROM 201 may utilize machine-learning algorithms to analyze the condition of the soil in which machine 101 is operating. Soil types (e.g., soft, hard, abrasive rocks) affect wear differently, and ROM 201 may dynamically adjust the wear predictions based on historical data and real-time feedback on soil conditions. In one instance, the ROM 201 may determine the force exerted on the component(s) of varying shapes. Complex shapes or components that experience uneven force distribution wear at different rates. By analyzing the force applied to each part of the component, the ROM 201 may estimate where the most wear is likely to occur, contributing to a precise wear rate prediction. In one instance, the ROM 201 may determine the speed at which the component(s) moves over the surface of the ground. Higher speed may be associated with increases in friction and wear rates. By monitoring the sliding velocity, the ROM 201 may adjust its predictions to reflect how increased or decreased speed influences the component's overall wear rate.

In one instance, the ROM 201 may apply a set of pre-defined rules to the sensor data for determining the wear rate of the component(s) of machine 101. The pre-defined rules may be based on mathematical models, material properties, and/or machine-specific performance parameters that guide how the sensor data is processed. In one example, ROM 201 may use pre-defined thresholds on the force exerted on the component(s), if the force exerted exceeds a specific limit over time, ROM 201 may calculate an accelerated wear rate. In one example, ROM 201 may use pre-defined thresholds on the speed at which the component(s) slide over the ground surface, with faster sliding speed resulting in a higher wear rate. In one example, ROM 201 may use pre-defined thresholds on material properties, where component(s) made from softer materials are assigned higher wear rates as opposed to component(s) made from harder materials that wear slowly. In one example, ROM 201 may use pre-defined thresholds on soil conditions, where highly abrasive soils like gravel may increase wear.

The ROM 201 may compare the wear rate with historical performance data to determine a deviation indicative of a change in performance. The historical data may serve as a baseline containing records of wear rate under similar operational conditions, such as force exerted, sliding speed, material property, or soil type. By comparing the current wear rate against the baseline, the ROM 201 may detect any unusual pattern or accelerated wear that deviates from expected performance trends. For example, if the wear rate significantly increases beyond historical averages (e.g., the quantitative wear rate is larger than an average value by a predetermined threshold amount or more), the ROM 201 may determine that the component is under excessive stress, improper usage, or harsher environment.

Once the deviation is detected, the ROM 201 may analyze the deviation to estimate the wear rate on the component(s), taking into account the intensity and nature of the deviations. The ROM 201 may generate quantitative wear predictions (e.g., expected degradation of the component(s)) based on the estimated wear rate. For example, if the wear rate indicates that front blade 103 is degrading at a specific rate per hour of operation, the ROM 201 may estimate how long front blade 103 can continue functioning before it reaches a critical wear threshold. Such wear prediction is quantified, often represented in terms such as the number of hours or work cycles remaining before maintenance or replacement is required.

In step 505, the ROM 201 may generate estimated wear (e.g., wear degeneration) of the component(s) of machine 101 based on the change in performance and/or the wear rate. In one instance, the ROM 201 may generate a three-dimensional model by mapping the wear rate into a geometric representation of the component(s) of machine 101. The three-dimensional model may visually represent the predicted areas of wear on the surface of the component(s) of machine 101. For example, the three-dimensional model may include color-coded regions corresponding to different levels of predicted wear, areas of minimal wear may be shown in green, while regions with moderate wear may be shown in yellow, and zones experiencing severe wear may be marked in red. The three-dimensional model may be dynamically updated, in real-time, near real-time, or periodically (e.g., at pre-set intervals), based on the sensor data from sensors 111 associated with machine 101.

In step 507, the ROM 201 may display an indication representing the estimated wear of the component(s) of machine 101 on a user interface of device(s) associated with the user(s) of machine 101 (e.g., operators). The user interface may provide real-time or near real-time visual feedback, allowing the users to monitor the health of the machine's components during operation. The indication of estimated wear may include three-dimensional models showing the extent of wear on various parts of the component(s) of machine 101. In addition to the visual element, the user interface may offer detailed metrics like the percentage of wear, estimated remaining life, and predicted failure timelines. By delivering this information in an easily accessible format, the ROM 201 may enable operators and maintenance teams to make informed decisions, schedule timely repairs, and optimize component usage.

In one instance, the ROM 201 may generate notification(s) (e.g., an alert) in the user interface of the device associated with the users (e.g., operators, drivers, managers, inspectors, etc.) upon determining the estimated wear exceeds a predetermined threshold. The recommended action(s) may include maintenance recommendations, recommendations to pause damaging operations, recommendations to order a new component to replace the worn component, or inspection recommendations to prevent the occurrence of the predicted wear or damage. For example, the system may generate an alert in the device specifically for ordering a replacement part when a component reaches a predetermined wear threshold. The alert may include specific details, such as the part number, the level of wear, and an estimated timeframe for when the component will no longer be effective. This alert can prompt the ordering of the new component, ensuring that replacement parts are procured before the current component fails. This predictive capability allows for planned maintenance interventions before a critical failure occurs, reducing unexpected downtime and costly repairs. Additionally, it enables the optimization of usage of the component(s) of machine 101 by scheduling maintenance activities during planned downtimes, minimizing disruption to operations, and maximizing overall equipment reliability and longevity.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A computer-implemented method for determining wear of one or more components of a machine, the method comprising:
receiving sensor data from one or more sensors associated with the machine;
processing the sensor data by a wear model for determining a change in performance and/or a wear rate of the one or more components;
generating an estimated wear of the one or more components with the wear model and based on the change in performance and/or the wear rate; and
displaying an indication representing the estimated wear of the one or more components on a user interface.

2. The computer-implemented method of claim 1, wherein the sensor data include one or more of blade position data or load data.

3. The computer-implemented method of claim 2, further comprising:
monitoring, continuously or periodically, position of one or more edges of the one or more components and detecting one or more of: deviations, angular positioning, or elevation of the one or more edges relative to a ground surface.

4. The computer-implemented method of claim 2, further comprising:
monitoring, in real-time or near real-time, dynamic load fluctuations and/or peak forces during tool operation for assessing operational stress to the one or more components.

5. The computer-implemented method of claim 1, wherein the wear model determines the wear rate of the one or more components based on at least one of:
hardness of surface of the one or more components;
machine-learning algorithms on soil conditions;
force exerted on the one or more components; or
speed at which the one or more components moves over a ground surface.

6. The computer-implemented method of claim 1, wherein processing the sensor data by the wear model, further comprises:
applying a set of pre-defined rules to the sensor data for determining the wear rate of the one or more components;
comparing the wear rate with historical performance data for determining a deviation from the historical performance data;
analyzing the deviation for estimating the wear rate of the one or more components; and
generating a quantitative wear prediction based on the estimated wear rate.

7. The computer-implemented method of claim 1, wherein generating the estimated wear comprises:
generating a three-dimensional model of the one or more components,
wherein the three-dimensional model visually represents predicted areas of wear on a surface of the one or more components.

8. The computer-implemented method of claim 7, wherein the three-dimensional model includes color-coded regions corresponding to different level of predicted wear, and wherein the three-dimensional model is updated in real-time or near real-time based on the sensor data.

9. The computer-implemented method of claim 7, wherein displaying the indication representing the estimated wear, further comprises:
generating one or more notifications in the user interface of a device upon determining the estimated wear exceeds a predetermined threshold,
wherein the one or more notifications includes one or more recommended actions, and wherein the recommended actions include ordering a new component based on the estimated wear.

10. The computer-implemented method of claim 1, wherein the one or more sensors include a linear displacement sensor, a rotary encoder, an accelerometer, a strain gauge, a load cell, a load sensing cylinder, or a pressure sensor.

11. A system for determining wear of one or more components of a machine comprising:
one or more processors; and
at least one non-transitory computer readable medium storing instructions which, when executed by the one or more processors, cause the one or more processors to perform operations comprising:
receiving sensor data from one or more sensors associated with the machine, wherein the sensor data includes one or more of: blade position data, load severity data, or soil condition data;
inputting the sensor data into a wear model for calculating wear rate and simulating a predicted wear of the one or more components; and
generating a three-dimensional model of the predicted wear, wherein the three-dimensional model indicates one or more of: worn geometry, worn volume, or wear rate of the one or more components.

12. The system of claim 11, wherein the wear model calculates the wear rate of the one or more components based on at least one of:
hardness of surface of the one or more components;
machine-learning algorithms on soil conditions;
force exerted on the one or more components of varying shapes; or
speed at which the one or more components slides over a ground surface.

13. The system of claim 11, wherein processing the sensor data by the wear model, further comprises:
applying a set of pre-defined rules to the sensor data for determining the wear rate of the one or more components;
comparing the wear rate with historical performance data for determining a deviation from the historical performance data ;
analyzing the deviation for estimating the wear rate of the one or more components; and
generating a quantitative wear prediction based on the estimated wear rate.

14. The system of claim 12, wherein generating the three-dimensional model comprises:
generating the three-dimensional model by mapping the wear rate into a geometric representation of the one or more components,
wherein the three-dimensional model visually represents predicted areas of wear on the surface of the one or more components.

15. The system of claim 12, wherein the worn geometry indicates reduction in thickness or surface deformation of the one or more components.

16. The system of claim 12, wherein the worn volume indicates total volume of material removed from original profile of the one or more components due to wear.

17. The system of claim 12, wherein the wear rate indicates a rate at which material is removed from the one or more components.

18. A non-transitory computer readable medium, the non-transitory computer readable medium storing instructions for determining wear of one or more components of a machine which, when executed by one or more processors of a computing system, cause the one or more processors to perform operations comprising:
receiving sensor data from one or more sensors associated with the machine;
processing the sensor data by a wear model for determining a wear volume rate of the one or more components; and
generating an estimated wear of the one or more components based on the wear volume rate.

19. The non-transitory computer readable medium of claim 18, wherein the wear model calculates the wear volume rate of the one or more components based on at least one of:
hardness of a surface of the one or more components;
soil conditions;
force exerted on the one or more components of varying shapes; or speed at which the one or more components moves over a ground surface.

20. The non-transitory computer readable medium of claim 18, wherein processing the sensor data by the wear model further comprises:
applying a set of pre-defined rules to the sensor data for determining the wear volume rate of the one or more components;
comparing the wear volume rate with historical performance data for determining a deviation from the historical performance data;
analyzing the deviation for estimating the wear volume rate of the one or more components; and
generating a quantitative wear predictions based on the estimated wear volume rate.
